(19) United States
(12) Patent Application Publication
(10) Pub. No.: US 2026/0249630 A1
(43) Pub. Date: Aug. 27, 2026

(54) PRINTING APPARATUS

(71) Applicant: SEIKO EPSON CORPORATION, Tokyo (JP)

(72) Inventors: Irwan SAPUTRA, Bekasi Regency (ID); Faridhul IKHSAN, Kabupaten Bekasi (ID); Muhamad AUF, Bekasi (ID); Hikaru KUMAGAI, Matsumoto (JP)

(21) Appl. No.: 19/547,761

(22) Filed: Feb. 24, 2026

(30) Foreign Application Priority Data
Feb. 26, 2025 (JP) 2025-029059

(51) Int. Cl. B41J 29/377; A62C 3/16; B41J 2/045; B41J 29/02; B41J 29/393

(52) U.S. Cl. CPC B41J 29/377; A62C 3/16; B41J 2/04581; B41J 29/02; B41J 29/393

(57) ABSTRACT

A printing apparatus includes a substrate including a first element to be supplied with an electric power of 100 W or more and a second element to be supplied with an electric power of less than 100 W. The first element is covered with a fire enclosure. The second element is not covered with the enclosure. The enclosure includes a housing and a first heat dissipation member. The housing is a flame-retardant resin member includes a wall portion and a top plate portion. The first heat dissipation member includes a first plate member and a second plate member. The first plate member has a first surface facing the substrate and a second surface fixed in contact with the top plate portion. The second plate member has a third surface and a fourth surface which are erected on the second surface along a direction normal to the second surface.

### CROSS REFERENCE TO RELATED APPLICATIONS

The present application is based on, and claims priority from JP Application Serial Number 2025-029059, filed Feb. 26, 2025, the disclosure of which is hereby incorporated by reference herein in its entirety.

### BACKGROUND

### 1. Technical Field

The present disclosure relates to a printing apparatus.

### 2. Related Art

In recent years, various electric appliances have been used, and the electric appliances continue to undergo technological evolution in order to improve the quality of life of human beings. As technologies evolve, electric appliances equipped with new technologies are produced, and safety standards are established worldwide so that electric appliances equipped with new technologies do not threaten human safety. For example, a safety standard IEC 62368-1 for information communication devices is defined as an international safety standard. With the evolution of technologies, IEC 62368-1 was also updated, and the fourth edition of IEC 62368-1 was established in 2023. IEC 62368-1 also relates to a fire enclosure provided to prevent the spread of fire when an electronic component heated to a high temperature ignites, as described in JP-A-2004-103907. Furthermore, as described in JP-A-2014-059346, an image forming apparatus has been invented in consideration of a fire enclosure.

However, there are few disclosures relating to a fire enclosure in an image forming apparatus or a printing apparatus. In addition, since high-temperature electronic components are covered, an inside of the enclosure is likely to be heated to a high temperature, and the electronic components in the fire enclosure are likely to be heated to a high temperature and easily catch fire. Therefore, there is room for improvement in a method of discharging heat in the enclosure while preventing the spread of fire in the printing apparatus.

### SUMMARY

According to an aspect of the present disclosure, a printing apparatus includes a transport section that transports a medium, an ejecting section that ejects liquid onto the medium, and a substrate including a first element to be supplied with an electric power of 100 W or more and a second element to be supplied with an electric power of less than 100 W. The first element is covered with a fire enclosure. The second element is not covered with the fire enclosure. The fire enclosure includes a housing and a first heat dissipation member. The housing is a flame-retardant resin member of at least V-1 grade, includes a wall portion and a top plate portion, and covers the first element. The wall portion is in contact with the substrate. The first heat dissipation member is made of aluminum and includes a first plate member and a second plate member. The first plate member has a first surface and a second surface opposite to the first surface. The first surface faces the substrate. The second surface is fixed in contact with the top plate portion. The second plate member has a third surface and a fourth surface opposite to the third surface, and the third surface and the fourth surface are erected on the second surface along a direction normal to the second surface.

### BRIEF DESCRIPTION OF THE DRAWINGS

FIG. 1 is a diagram illustrating a schematic configuration of a printing apparatus.

FIG. 2 is a diagram illustrating a functional configuration of the printing apparatus.

FIG. 3 is a diagram illustrating a circuit configuration of a power supply circuit.

FIG. 4 is a diagram illustrating a circuit configuration of a drive circuit.

FIG. 5 is a diagram schematically illustrating a configuration of an ejecting section.

FIG. 6 is a diagram illustrating an example of a signal waveform of a drive signal.

FIG. 7 is a diagram illustrating an example of the relationship between sizes of dots formed on a medium and signal waveforms of drive voltages.

FIG. 8 is a diagram illustrating an example of a functional configuration of a drive signal selection circuit.

FIG. 9 is a diagram illustrating an example of decoding contents of a decoder included in a selection control circuit.

FIG. 10 is a diagram illustrating an example of a configuration of a selection circuit corresponding to the ejecting section.

FIG. 11 is a diagram for illustrating specific examples of a latch signal, a change signal, a clock signal, and a print data signal.

FIG. 12 is a perspective view of a substrate provided with a fire enclosure.

FIG. 13 is a side view of the substrate in a state in which the fire enclosure illustrated in FIG. 12 is cut.

FIG. 14 is a view of a housing as viewed from a tip of an arrow indicating a direction of a Z-axis.

FIG. 15 is a perspective view of a heat dissipation member.

FIG. 16 is a perspective view of a heat dissipation member according to a modification.

FIG. 17 is a perspective view of a heat dissipation member according to another modification.

FIG. 18 is a perspective view of a heat dissipation member according to a further modification.

FIG. 19 is a perspective view of a substrate provided with a fire enclosure according to a still further modification.

FIG. 20 is a side view of the substrate in a state in which the fire enclosure illustrated in FIG. 19 is cut.

### DESCRIPTION OF EMBODIMENTS

Hereinafter, preferred embodiments of the present disclosure will be described with reference to the accompanying drawings. The drawings to be used are for convenience of description. Note that the embodiments to be described below do not inappropriately limit the contents of the present disclosure described in claims. In addition, it is not necessarily the case that all components described below are essential components of the present disclosure.

An ink jet printer will be described below as an example of a printing apparatus according to the present disclosure.

### 1. Overview of Printing Apparatus

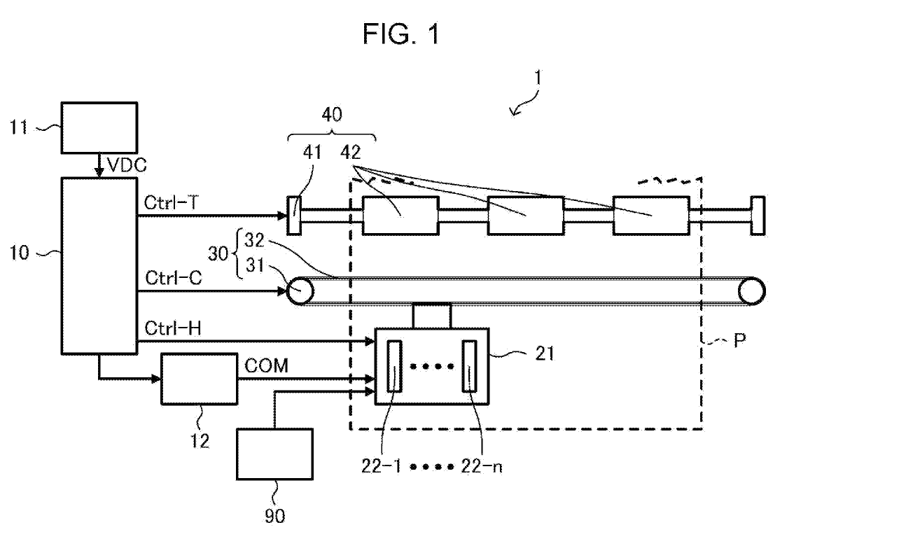

FIG. 1 is a diagram schematically illustrating an example of a configuration of a printing apparatus 1. The printing apparatus 1 of this embodiment is a so-called serial printing type ink jet printer in which a carriage 21 on which print heads 22-1 to 22-n are mounted reciprocates along a scanning axis, and the print heads 22-1 to 22-n eject ink as an example of a liquid to a medium P transported along a transport direction, thereby forming a desired image on the medium P. As the medium P used in the printing apparatus 1, in addition to printing paper, such as plain paper, any printing medium, such as a resin film or fabric, can be used. In addition, a size of the medium P may be equal to or smaller than an A3 short side width.

As illustrated in FIG. 1, the printing apparatus 1 includes a control circuit board 10, a power supply circuit board 11, a drive circuit board 12, print heads 22-1 to 22-n, a moving unit 30, a transport unit 40, and an ink container 90.

A plurality of types of ink to be ejected to the medium P are stored in the ink container 90. An ink cartridge, a bag-shaped ink pack formed of a flexible film, an ink tank that can be replenished with ink, or the like can be used as the ink container 90.

A control circuit including a processing circuit, such as a central processing unit (CPU) or a field programmable gate array (FPGA) and a storage circuit, such as a semiconductor memory, is mounted on the control circuit board 10. The control circuit controls the individual components of the printing apparatus 1 and controls ejection of ink from ejecting sections 600[1] to 600[p] to be described later.

A power supply circuit is mounted on the power supply circuit board 11. For example, the power supply circuit generates a power supply voltage VDC, which is a direct-current (DC) voltage having a constant voltage value of 48 V, for example, from a signal of an alternating-current (AC) voltage of a commercial power supply or the like supplied to the printing apparatus 1, and outputs the power supply voltage VDC to the individual sections of the printing apparatus 1. The power supply circuit includes, for example, an AC/DC converter, such as a flyback circuit, and may further include a DC/DC converter.

A drive circuit that generates a drive signal COM based on data supplied from the control circuit is mounted on the drive circuit board 12. The drive signal COM causes the ejecting sections 600[1] to 600[p] described later to eject ink.

The print heads 22-1 to 22-n are mounted on the carriage 21. To the print heads 22-1 to 22-n, a control signal Ctrl-H is supplied from the control circuit board 10, and the drive signal COM is supplied from the drive circuit board 12. In addition, the ink stored in the ink container 90 is supplied to the print heads 22-1 to 22-n via a tube (not illustrated) or the like. Each of the print heads 22-1 to 22-n ejects the supplied ink onto the medium P based on the control signal Ctrl-H and the drive signal COM.

The moving unit 30 includes a carriage motor 31 and an endless belt 32. The carriage motor 31 operates based on the control signal Ctrl-C supplied from the control circuit board 10. The carriage 21 on which the print heads 22-1 to 22-n are mounted is fixed to the endless belt 32. In addition, the endless belt 32 rotates in accordance with the operation of the carriage motor 31. Then, the carriage 21 fixed to the endless belt 32 moves along a scanning direction by rotation of the endless belt 32. That is, the moving unit 30 controls a movement of the print heads 22-1 to 22-n mounted on the carriage 21.

The transport unit 40 includes a transport motor 41 and transport rollers 42. The transport motor 41 operates based on a control signal Ctrl-T supplied from the control circuit board 10. The transport rollers 42 rotate in accordance with an operation of the transport motor 41 while holding the medium P. The medium P held by the transport rollers 42 is transported along a transport direction by the rotation of the transport rollers 42. That is, the transport unit 40 transports the medium P.

In the printing apparatus 1 configured as described above, the moving unit 30 controls the reciprocation of the carriage 21 along the scanning direction, and the transport unit 40 controls the transport of the medium P along the transport direction. Then, each of the print heads 22-1 to 22-n mounted on the carriage 21 ejects ink to the medium P in conjunction with the reciprocating motion of the carriage 21 and the transport of the medium P. As a result, the ink ejected from each of the print heads 22-1 to 22-n lands on any surface of the medium P, and a desired image is formed on the medium P.

### 2. Functional Configuration of Printing Apparatus

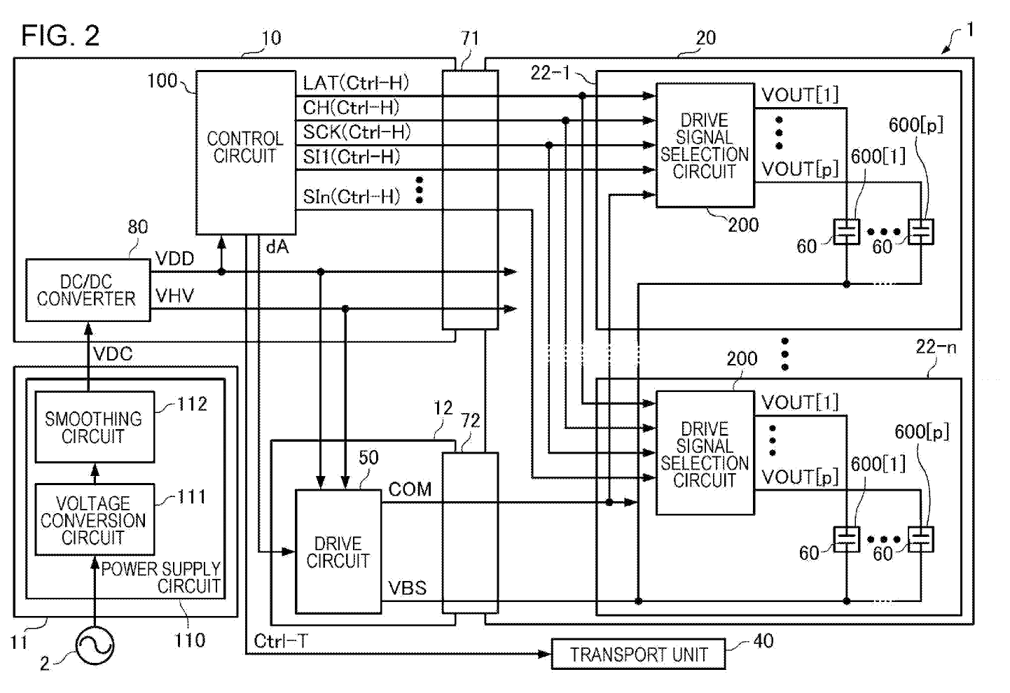

Next, a functional configuration of the printing apparatus 1 will be described. FIG. 2 is a diagram illustrating a functional configuration of the printing apparatus 1. As illustrated in FIG. 2, the printing apparatus 1 includes the control circuit board 10, the power supply circuit board 11, the drive circuit board 12, the head unit 20, and the transport unit 40.

The control circuit board 10 and the head unit 20 are connected to each other by a cable 71. The drive circuit board 12 and the head unit 20 are connected by a cable 72. The cables 71 and 72 are a sliding cable that can follow a movement of the carriage 21, and may be, for example, a flexible flat cable (FFC).

A power supply circuit 110 is mounted on the power supply circuit board 11. The power supply circuit 110 includes a voltage conversion circuit 111 and a smoothing circuit 112. The voltage conversion circuit 111 transforms a signal of an AC voltage of a commercial power supply or the like and outputs the transformed AC voltage to the smoothing circuit 112. The smoothing circuit 112 smoothes the AC voltage output from the voltage conversion circuit 111 and outputs a DC power supply voltage VDC.

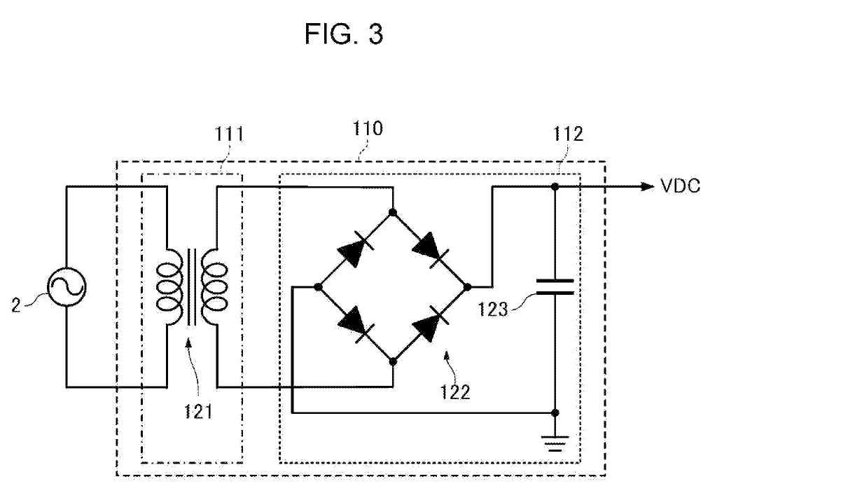

FIG. 3 is a circuit diagram schematically illustrating configurations of the voltage conversion circuit 111 and the smoothing circuit 112. As illustrated in FIG. 3, the voltage conversion circuit 111 includes a transformer 121. For example, the transformer 121 transforms the AC voltage of 100 V of the commercial power supply 2 and outputs the transformed AC voltage to the smoothing circuit 112. As illustrated in FIG. 3, the smoothing circuit 112 includes a rectifier circuit 122 and a capacitor 123. The rectifier circuit 122 is, for example, a diode bridge circuit including a plurality of diodes, and rectifies the AC voltage converted by the voltage conversion circuit 111. The capacitor 123 is a smoothing capacitor that smoothes a voltage rectified by the rectifier circuit 122, converts the voltage into, for example, a DC voltage of 48 V, and outputs a power supply voltage VDC of the DC voltage.

Returning to the description with reference to FIG. 2, the DC/DC converter 80 and the control circuit 100 are mounted on the control circuit board 10.

The DC/DC converter 80 steps down a power supply voltage VDC output from the smoothing circuit 112 of the power supply circuit 110, generates a power supply voltage VDD which is a constant DC voltage with a voltage value of 3.3 V, for example, outputs the power supply voltage VDD to the control circuit 100 and the drive circuit 50, and outputs the power supply voltage VDD to the head unit 20 via the cable 71. Furthermore, the DC/DC converter 80 steps down the power supply voltage VDC, generates, for example, a power supply voltage VHV which is a DC voltage having a constant voltage value of 42 V, outputs the power supply voltage VHV to the drive circuit 50, and outputs the power supply voltage VHV to the head unit 20 via the cable 71.

The control circuit 100 includes, for example, a processor, such as a microcontroller, and is communicably connected to an external device, such as a host computer (not illustrated), provided outside the printing apparatus 1. An image information signal including image data formed on the medium P from the external device is input to the control circuit 100. The control circuit 100 generates various types of data for controlling the printing apparatus 1 and signals corresponding to the data by performing predetermined image processing on the input image information signal.

The control circuit 100 generates a control signal Ctrl-T for controlling the transport of the medium P, and outputs the control signal Ctrl-T to the transport unit 40. As a result, the transport motor 41 included in the transport unit 40 is rotationally driven, and the transport in the transport direction of the medium P is controlled. Here, the control signal Ctrl-T output by the control circuit 100 may be input to the transport motor 41 after being subjected to signal conversion in a driver circuit (not illustrated).

Moreover, the control circuit 100 generates a latch signal LAT, a change signal CH, a clock signal SCK, and print data signals SI1 to SIn as the control signal Ctrl-H for controlling the head unit 20 based on the input image information signal, and outputs the latch signal LAT, the change signal CH, the clock signal SCK, and the print data signals SI1 to SIn to the head unit 20 via the cable 71. Note that the latch signal LAT, the change signal CH, the clock signal SCK, and the print data signals SI1 to SIn will be described later in detail.

A drive circuit 50 is mounted on the drive circuit board 12. The control circuit 100 outputs a base drive signal dA, which is a digital signal, to the drive circuit 50. The drive circuit board 12 may be mounted on the head unit 20.

The drive circuit 50 generates a drive signal COM including one or a plurality of signal waveforms by performing digital/analog signal conversion on the base drive signal dA of the input digital signal and then performing class-D amplification on the converted analog signal. The drive circuit 50 may generate a plurality of drive signals COM. Then, the drive circuit 50 outputs the generated drive signal COM to the head unit 20 via the cable 72. Here, the base drive signal dA is a digital signal for defining a signal waveform of the drive signal COM, and the drive circuit 50 generates the drive signal COM, which is an analog signal, by performing class-D amplification on the signal waveform defined by the base drive signal dA. That is, the base drive signal dA is a digital signal serving as a base of the drive signal COM output from the drive circuit 50. However, the base drive signal dA may be an analog signal as long as it can define a signal waveform of the drive signal COM. In addition, the drive circuit 50 may amplify the signal waveform defined by the base drive signal dA and output the amplified signal waveform as the drive signal COM. Therefore, the drive circuit 50 may generate the drive signal COM by performing class-A amplification, class-B amplification, or class AB-amplification on the signal waveform defined by the base drive signal dA.

In addition, the drive circuit 50 generates a reference voltage VBS which is a reference potential for driving a piezoelectric element 60 which is included in the head unit 20 and will be described later. Then, the drive circuit 50 outputs the generated reference voltage VBS to the head unit 20 via the cable 72. The reference voltage VBS may be, for example, a ground potential having a voltage value of 0 V, or a DC voltage having a voltage value of 5.5 V, 6 V, or the like.

The head unit 20 includes the print heads 22-1 to 22-n. Furthermore, the print head 22-i includes a drive signal selection circuit 200 and p ejecting sections 600[1] to 600[p]. Here, i is an integer of 1 or more and n or less.

The drive signal selection circuit 200 includes one or a plurality of integrated circuit devices. The latch signal LAT, the change signal CH, the clock signal SCK, the print data signal SIi, and the drive signal COM are input to the drive signal selection circuit 200. The drive signal selection circuit 200 generates and outputs drive voltages VOUT[1] to VOUT[p] that correspond to the ejecting sections 600[1] to 600[p], respectively, by selecting or deselecting the signal waveforms of the drive signal COM based on the input latch signal LAT, the input change signal CH, the input clock signal SCK, and the input print data signal SIi. That is, the drive signal selection circuit 200 functions as a drive controller that controls the application of the drive signal COM to the ejecting sections 600[1] to 600[p]. Note that a configuration and operation of the drive signal selection circuit 200 will be described later in detail.

Each of the ejecting sections 600[1] to 600[p] includes a piezoelectric element 60. The drive voltage VOUT[j] output by the drive signal selection circuit 200 is supplied to one end of the piezoelectric element 60 included in the ejecting section 600[j]. Here, j is an integer of 1 or more and p or less. In addition, the reference voltage VBS is commonly supplied to the other ends of the p piezoelectric elements 60 included in the ejecting sections 600[1] to 600[p]. The piezoelectric element 60 included in the ejecting section 600[j] is displaced by a potential difference between the drive voltage VOUT[j] and the reference voltage VBS. The ink having an amount corresponding to the displacement of the piezoelectric element 60 is ejected from the corresponding ejecting section 600[j]. Since the drive voltage VOUT[j] is generated by selecting or deselecting the signal waveform of the drive signal COM, in other words, the ejecting section 600[j] ejects ink when the drive signal COM is applied. Then, the ink ejected from the ejecting sections 600[1] to 600[p] included in each of the print heads 22-1 to 22-n lands on the medium P, and thus an image is formed on the medium P.

As described above, the drive voltage VOUT[j] generated based on the latch signal LAT, the change signal CH, the clock signal SCK, and the print data signal SIi is applied to the ejecting section 600[j] included in the print head 22-i, and the ejecting section 600[j] ejects the ink to the medium P. In other words, the latch signal LAT, the change signal CH, the clock signal SCK, and the print data signals SI1 to SIn are individually ejection control signals that control the ejection of the ink to the medium P of the ejecting section 600[j], and the ejecting section 600[j] ejects the ink to the medium P based on the ejection control signals.

Here, the print heads 22-1 to 22-n all have the same configuration, and may be referred to as a print head 22 when it is not necessary to distinguish the print heads 22-1 to 22-n. In this case, the description will be made on the assumption that the print data signal SI is input to the print head 22 as the print data signals SI1 to SIn. In addition, the ejecting sections 600[1] to 600[p] included in the print head 22 all have the same configuration, and may be simply referred to as an ejecting section 600 when it is not necessary to distinguish the ejecting sections 600[1] to 600[p]. In this case, the description will be made on the assumption that the drive voltage VOUT is supplied to the ejecting section 600 as the drive voltages VOUT[1] to VOUT[p].

### 3. Configuration of Drive Circuit

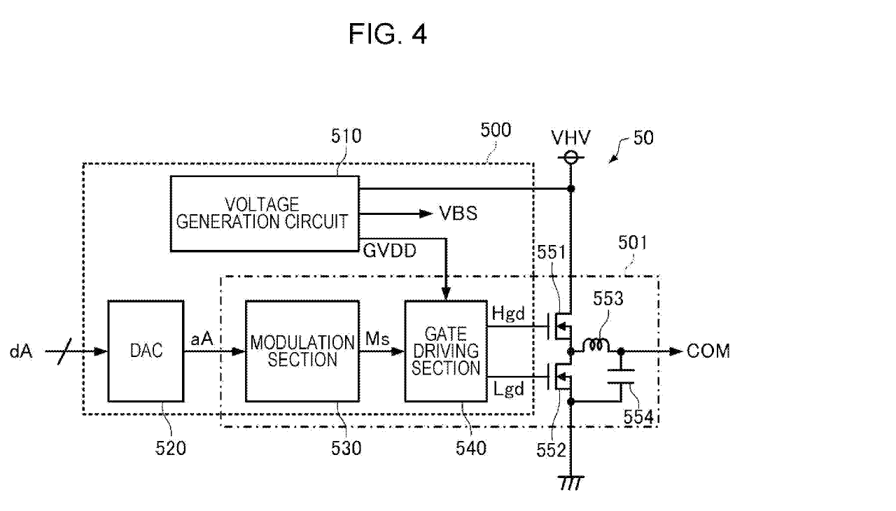

FIG. 4 is a diagram illustrating a circuit configuration of the drive circuit 50. As illustrated in FIG. 4, the drive circuit 50 includes an integrated circuit 500, transistors 551 and 552, a coil 553, and a capacitor 554. The integrated circuit 500 includes a voltage generation circuit 510, a DAC 520, a modulation section 530, and a gate driving section 540. DAC is an abbreviation for Digital to Analog Converter.

The voltage generation circuit 510 generates a voltage GVDD based on a power supply voltage VHV. The voltage GVDD is a DC voltage having a voltage value of, for example, 7.5 V, and is input to the gate driving section 540. The voltage generation circuit 510 generates a reference voltage VBS based on the power supply voltage VHV.

The base drive signal dA is input to the DAC 520. The DAC 520 converts the input base drive signal dA into an analog base drive signal aA. The base drive signal aA is a target signal before the amplification of the drive signal COM. The base drive signal aA is input to the modulation section 530. The modulation section 530 outputs a modulation signal Ms obtained by performing pulse width modulation on the base drive signal aA. The voltages VHV and GVDD and the modulation signal Ms are input to the gate driving section 540. The gate driving section 540 amplifies the input modulation signal Ms based on the voltage GVDD and inverts logic levels of an amplification control signal Hgd, which is level-shifted to a high amplitude logic level based on the voltage VHV, and the input modulation signal Ms, to generate an amplification control signal Lgd based on the voltage GVDD. That is, the amplification control signal Hgd and the amplification control signal Lgd are at the H level mutually exclusively.

The voltage VHV is supplied to a drain terminal of the transistor 551. The amplification control signal Hgd is supplied to a gate terminal of the transistor 551. A source terminal of the transistor 551 is electrically coupled to a drain terminal of the transistor 552. In addition, the amplification control signal Lgd is supplied to a gate terminal of the transistor 552. A source terminal of the transistor 552 is connected to the ground. The transistor 551, which is coupled as described above, operates in accordance with the amplification control signal Hgd, and the transistor 552 operates in accordance with the amplification control signal Lgd. That is, the transistor 551 and the transistor 552 are turned on mutually exclusively. As a result, an amplified modulation signal obtained by amplifying the modulation signal Ms based on the voltage VHV is generated at a coupling point between the source terminal of the transistor 551 and the drain terminal of the transistor 552. Each of the transistors 551 and 552 is, for example, an N-channel FET. FET is an abbreviation for Field Effect Transistor.

One end of the coil 553 is commonly coupled to the source terminal of the transistor 551 and the drain terminal of the transistor 552. Furthermore, the other end of the coil 553 is coupled to one end of the capacitor 554. The other end of the capacitor 554 is coupled to the ground. That is, the coil 553 and the capacitor 554 constitute a low-pass filter. Then, the amplified modulation signal is supplied to the low-pass filter, so that the amplified modulation signal is demodulated and a drive signal COM is generated. The drive circuit 50 outputs the drive signal COM generated as described above.

As described above, the drive circuit 50 generates the drive signal COM by subjecting the base drive signal dA to digital/analog conversion and then to class-D amplification. That is, the DAC 520, the modulation section 530, the gate driving section 540, the transistors 551 and 552, the coil 553, and the capacitor 554 constitute an amplification circuit 501, and the amplification circuit 501 is a class-D amplifier. However, the drive circuit 50 may generate the drive signal COM by performing class-A amplification, class-B amplification, or class-AB amplification on the signal waveform defined by the base drive signal dA.

### 4. Structure of Ejecting Sections

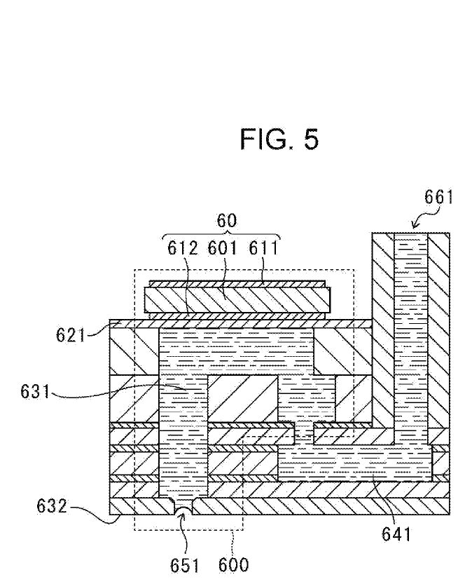

Next, the structure of the ejecting sections 600 will be described. FIG. 5 is a diagram for illustrating a schematic configuration of one of the ejecting sections 600. In addition to the ejecting section 600, FIG. 5 illustrates a nozzle plate 632, a reservoir 641, and a supply port 661.

As illustrated in FIG. 5, each of the ejecting sections 600 includes a piezoelectric element 60, a diaphragm 621, a cavity 631, and a nozzle 651. Furthermore, the piezoelectric element 60 includes a piezoelectric body 601 and electrodes 611 and 612. The piezoelectric element 60 is configured such that the electrodes 611 and 612 are positioned to interpose the piezoelectric body 601. The piezoelectric element 60 is driven such that a center portion is displaced in the up-down direction according to a potential difference between a voltage supplied to the electrode 611 and the voltage supplied to the electrode 612. Specifically, the drive voltage VOUT based on the drive signal COM is supplied to the electrode 611, and the reference voltage VBS is supplied to the electrode 612. When a voltage value of the drive voltage VOUT supplied to the electrode 611 changes, a potential difference between the drive voltage VOUT supplied to the electrode 611 and the reference voltage VBS supplied to the electrode 612 changes. As a result, the piezoelectric element 60 is driven such that the center portion is displaced in the up-down direction.

The diaphragm 621 is positioned below the piezoelectric element 60 in FIG. 5. In other words, the piezoelectric element 60 is formed on an upper surface of the diaphragm 621 in FIG. 5. The diaphragm 621 is displaced in the up-down direction as the piezoelectric element 60 is driven in the up-down direction.

The cavity 631 is positioned below the diaphragm 621 in FIG. 5. Ink is supplied to the cavity 631 from the reservoir 641. In addition, the ink stored in the ink container 90 is introduced into the reservoir 641 via the supply port 661. That is, the inside of the cavity 631 is filled with the ink stored in the ink container 90. An internal volume of the cavity 631 expands or contracts as the diaphragm 621 is displaced in the up-down direction. That is, the diaphragm 621 functions as a diaphragm that changes the internal volume of the cavity 631, and the cavity 631 functions as a pressure chamber of which the pressure changes as the diaphragm 621 is displaced in the up-down direction.

The nozzle 651 is an opening portion which is provided on the nozzle plate 632 and communicates with the cavity 631. When the internal volume of the cavity 631 changes, the ink filling the inside of the cavity 631 is ejected from the nozzle 651 according to the change in the internal volume.

In the ejecting section 600 configured as described above, when the piezoelectric element 60 is driven to bend in the upward direction, the diaphragm 621 is displaced upward. As a result, the internal volume of the cavity 631 expands, and as a result, the ink stored in the reservoir 641 is drawn into the cavity 631. On the other hand, when the piezoelectric element 60 is driven to bend in the downward direction, the diaphragm 621 is displaced downward. As a result, the internal volume of the cavity 631 contracts, and as a result, the ink having an amount corresponding to a degree of contraction of the internal volume of the cavity 631 is ejected from the nozzle 651.

Note that the piezoelectric element 60 is not limited to the structure illustrated in FIG. 5 as long as the piezoelectric element 60 is driven by being supplied with the drive voltage VOUT corresponding to the drive signal COM and can eject ink from the nozzle 651 when driven.

### 5. Functional Configuration of Drive Signal Selection Circuit

Next, a configuration and an operation of the drive signal selection circuit 200 will be described. In describing a configuration and an operation of the drive signal selection circuit 200, an example of a signal waveform of the drive signal COM input to the drive signal selection circuit 200 and an example of a signal waveform of the drive voltage VOUT output from the drive signal selection circuit 200 will be described.

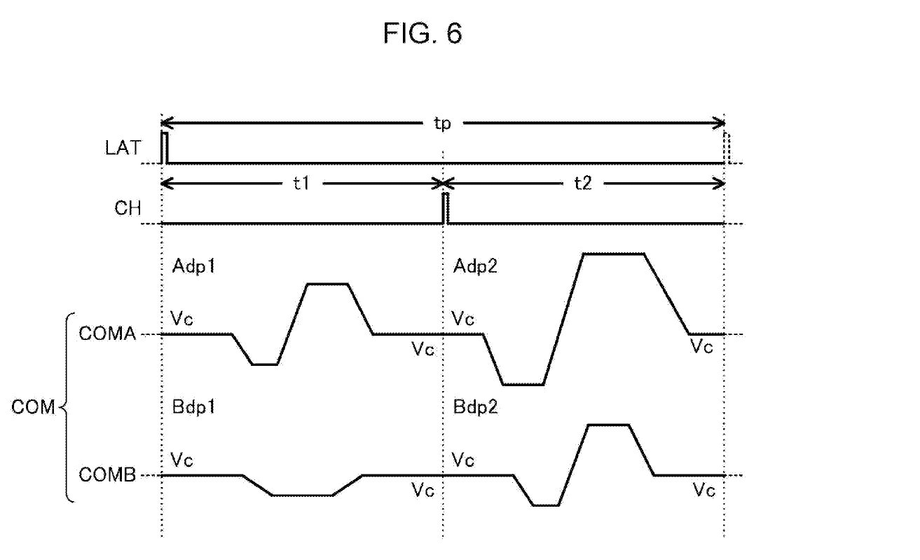

FIG. 6 is a diagram illustrating an example of the signal waveform of the drive signal COM. In FIG. 6, a drive signal COMA and a drive signal COMB are exemplified as two drive signals COM.

The drive signal COMA has a signal waveform in which a trapezoidal waveform Adp1 in a period t1 from a rise of the latch signal LAT to a rise of the change signal CH, and a trapezoidal waveform Adp2 in a period t2 from the rise of the change signal CH to a rise of the latch signal LAT are continuous to each other. Furthermore, the trapezoidal waveform Adp1 is a signal waveform for ejecting a predetermined amount of ink from the ejecting section 600 when supplied to the piezoelectric element 60 included in the ejecting section 600, and the trapezoidal waveform Adp2 is a signal waveform for ejecting an amount of ink larger than a predetermined amount from the ejecting section 600 when supplied to the piezoelectric element 60 included in the ejecting section 600. Here, in the following description, when the trapezoidal waveform Adp1 is supplied to the piezoelectric element 60 included in the ejecting section 600, the amount of ink ejected from the ejecting section 600 is referred to as a small amount, and when the trapezoidal waveform Adp2 is supplied to the piezoelectric element 60 included in the ejecting section 600, the amount of ink ejected from the ejecting section 600 is referred to as a medium amount.

As illustrated in FIG. 6, the drive signal COMB has a signal waveform in which a trapezoidal waveform Bdp1 in the period t1 and a trapezoidal waveform Bdp2 in the period t2 are continuous to each other. Furthermore, the trapezoidal waveform Bdp1 is a signal waveform for not ejecting the ink from the ejecting section 600 when supplied to the piezoelectric element 60 included in the ejecting section 600, and the trapezoidal waveform Bdp2 is a signal waveform for ejecting a small amount of ink from the ejecting section 600 when supplied to the piezoelectric element 60 included in the ejecting section 600. Here, the trapezoidal waveform Bdp1 is a signal waveform for preventing an increase in ink viscosity by vibrating the ink in the vicinity of a nozzle opening portion included in the ejecting section 600 to such an extent that the ink is not ejected. In the following description, when the trapezoidal waveform Bdp1 is supplied to the piezoelectric element 60 included in the ejecting section 600, an operation of vibrating the ink in the vicinity of the nozzle opening portion may be referred to as microvibration.

Here, as illustrated in FIG. 6, voltage values at start timings and end timings of the trapezoidal waveforms Adp1, Adp2, Bdp1, and Bdp2 are all common to a voltage Vc. In other words, each of the trapezoidal waveforms Adp1, Adp2, Bdp1, and Bdp2 starts at the voltage Vc and ends at the voltage Vc. Then, a cycle tp including the period t1 and the period t2 corresponds to a print cycle for forming a new dot on the medium P.

Although FIG. 6 illustrates a case where the trapezoidal waveform Adp1 and the trapezoidal waveform Bdp2 have the same signal waveform, the trapezoidal waveform Adp1 and the trapezoidal waveform Bdp2 may have different signal waveforms. In addition, it is described that a small amount of ink is ejected from the common ejecting section 600 when the trapezoidal waveform Adp1 is supplied to the piezoelectric element 60 included in the ejecting section 600 and when the trapezoidal waveform Bdp2 is supplied to the piezoelectric element 60 included in the ejecting section 600, but the present disclosure is not limited thereto. In other words, the signal waveforms of the drive signals COMA and COMB are not limited to the signal waveforms illustrated in FIG. 6, and combinations of various signal waveforms may be used depending on the nature of the ink ejected from the ejecting section 600, material of the medium P on which the ejected ink lands, and the like.

Furthermore, in FIG. 6, the case where the timing at which the trapezoidal waveform Adp1 and the trapezoidal waveform Adp2 included in the drive signal COMA are switched, and the timing at which the trapezoidal waveform Bdp1 and the trapezoidal waveform Bdp2 included in the drive signal COMB are switched are defined by one change signal CH is exemplified. However, the change signal CH that defines the timing at which the trapezoidal waveform Adp1 and the trapezoidal waveform Adp2 included in the drive signal COMA are switched, and the change signal CH that defines the timing at which the trapezoidal waveform Bdp1 and the trapezoidal waveform Bdp2 included in the drive signal COMB are switched, may be different signals.

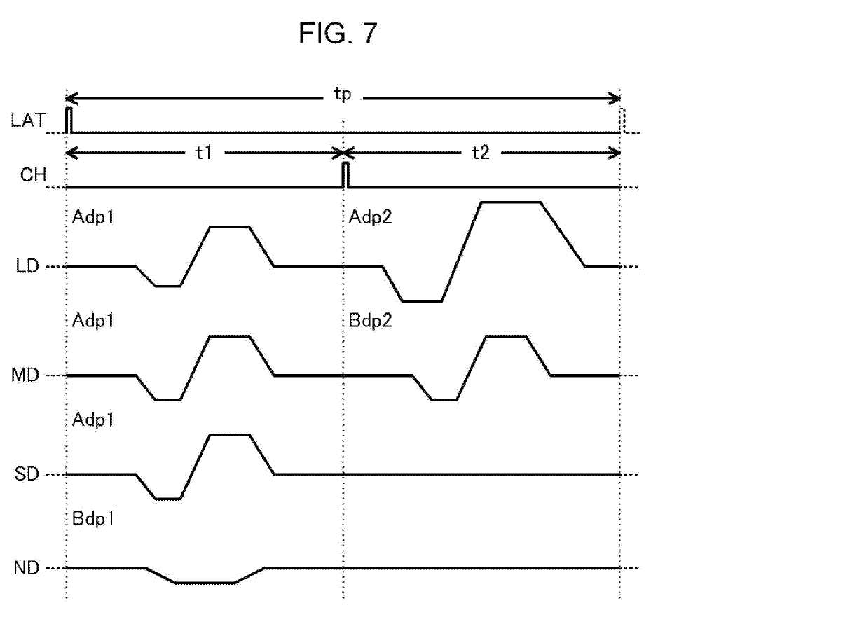

FIG. 7 is a diagram illustrating an example of the signal waveform of the drive voltage VOUT when a size of a dot formed on the medium P is any of a large dot LD, a medium dot MD, a small dot SD, and non-recording ND.

As illustrated in FIG. 7, the drive voltage VOUT when the large dot LD is formed on the medium P has a signal waveform in which the trapezoidal waveform Adp1 arranged in the period t1 in the cycle tp and the trapezoidal waveform Adp2 arranged in the period t2 in the cycle tp are continuous to each other. When the drive voltage VOUT is supplied to the piezoelectric element 60 included in the ejecting section 600, a small amount of ink and a medium amount of ink are ejected from the corresponding ejecting section 600. Therefore, the individual types of ink land on the medium P and coalesce to form a large dot LD on the medium P in the cycle tp.

The drive voltage VOUT when the medium dot MD is formed on the medium P has a signal waveform in which the trapezoidal waveform Adp1 in the period t1 in the cycle tp and the trapezoidal waveform Bdp2 in the period t2 in the cycle tp are continuous to each other. When the drive voltage VOUT is supplied to the piezoelectric element 60 included in the ejecting section 600, a small amount of ink is ejected twice from the corresponding ejecting section 600. Therefore, the individual types of ink land on the medium P and coalesce to form a medium dot MD on the medium P in the cycle tp.

The drive voltage VOUT when the small dot SD is formed on the medium P has a signal waveform in which the trapezoidal waveform Adp1 in the period t1 in the cycle tp and a constant signal waveform in the period t2 in the cycle tp at the voltage Vc are continuous to each other. When the drive voltage VOUT is supplied to the piezoelectric element 60 included in the ejecting section 600, a small amount of ink is ejected once from the corresponding ejecting section 600. Therefore, the ink lands on the medium P to form the small dot SD on the medium P in the cycle tp.

The drive voltage VOUT that corresponds to the non-recording ND that does not form dots on the medium P has a signal waveform in which the trapezoidal waveform Bdp1 in the period t1 in the cycle tp and a constant signal waveform in the period t2 in the cycle tp at the voltage Vc are continuous to each other. When the drive voltage VOUT is supplied to the piezoelectric element 60 included in the ejecting section 600, the ink in the vicinity of the nozzle opening portion of the corresponding ejecting section 600 merely undergoes microvibration, and no ink is ejected from the ejecting section 600. Therefore, dots are not formed on the medium P in the cycle tp.

Here, in the constant signal waveform at the voltage Vc in the drive voltage VOUT, when none of the trapezoidal waveforms Adp1, Adp2, Bdp1, and Bdp2 is selected as the drive voltage VOUT, the voltage Vc immediately before the trapezoidal waveforms Adp1, Adp2, Bdp1, and Bdp2 corresponds to a voltage value held by a capacitive component of the piezoelectric element 60 included in the ejecting section 600. In other words, when none of the trapezoidal waveforms Adp1, Adp2, Bdp1, and Bdp2 is selected as the drive voltage VOUT, the voltage Vc supplied immediately before is supplied to the piezoelectric element 60 included in the ejecting section 600 as the drive voltage VOUT.

Here, as illustrated in FIG. 7, the drive signal selection circuit 200 selects or deselects the trapezoidal waveforms Adp1 and Adp2 included in the drive signal COMA and the trapezoidal waveforms Bdp1 and Bdp2 included in the drive signal COMB to generate drive voltages VOUT individually corresponding to the plurality of ejecting sections 600 and output the drive voltages VOUT to the piezoelectric elements 60 included in the corresponding ejecting sections 600.

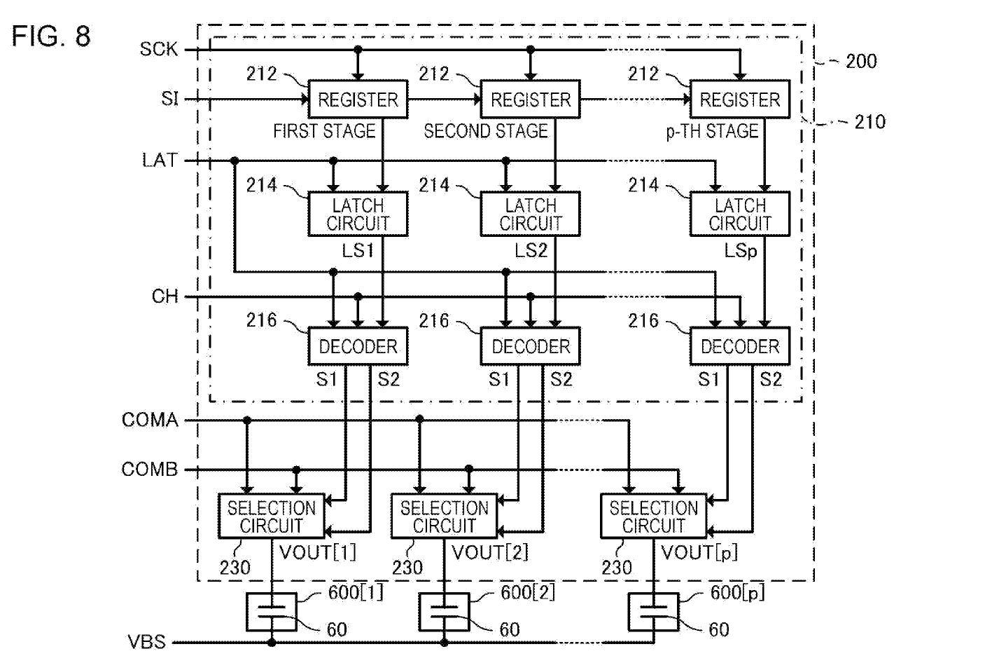

FIG. 8 is a view illustrating a functional configuration of the drive signal selection circuit 200. As illustrated in FIG. 8, the drive signal selection circuit 200 includes a selection control circuit 210 and a plurality of selection circuits 230. Furthermore, in FIG. 8, the ejecting sections 600[1] to 600[p] to which the drive voltages VOUT[1] to VOUT[p] output from the drive signal selection circuit 200 are supplied are also illustrated.

The print data signal SI, the clock signal SCK, the latch signal LAT, and the change signal CH are input to the selection control circuit 210. In the selection control circuit 210, a set of a register 212, a latch circuit 214, and a decoder 216 is provided for each of the ejecting sections 600[1] to 600[p]. That is, the selection control circuit 210 includes at least the same number of sets of the registers 212, the latch circuits 214, and the decoders 216 as the number of the ejecting sections 600[1] to 600[p].

The print data signal SI is synchronized with the clock signal SCK and has a total of 2p bits serially including 2-bit print data items [SIH, SIL] for selecting one of the large dot LD, the medium dot MD, the small dot SD, and the non-recording ND for each of the ejecting sections 600[1] to 600[p]. The print data signal SI is held in the registers 212 for individual print data items [SIH, SIL] included in the print data signal SI in correspondence with the ejecting sections 600[1] to 600[p].

Specifically, in the selection control circuit 210, the registers 212 are connected in series to constitute a p-stage shift register. Then, the print data items [SIH, SIL] serially input as the print data signal SI are sequentially transferred to the registers 212 in the subsequent stage in accordance with the clock signal SCK. Then, when the supply of the clock signal SCK is stopped, the print data items [SIH, SIL] corresponding to the individual ejecting sections 600[1] to 600[p] are held in the registers 212 corresponding to the individual ejecting sections 600[1] to 600[p]. Note that, in the following description, in order to distinguish the p registers 212 that constitute the shift register, the registers 212 may be referred to as registers 212 of a first stage, a second stage, ..., and a p-th stage from the upstream to the downstream of the supply of the print data signal SI.

The p latch circuits 214 are individually provided for the p registers 212. The individual latch circuits 214 latch the print data items [SIH, SIL] held in the corresponding p registers 212 all at once at a rise of the latch signal LAT, and output the print data items [SIH, SIL] to the corresponding decoders 216.

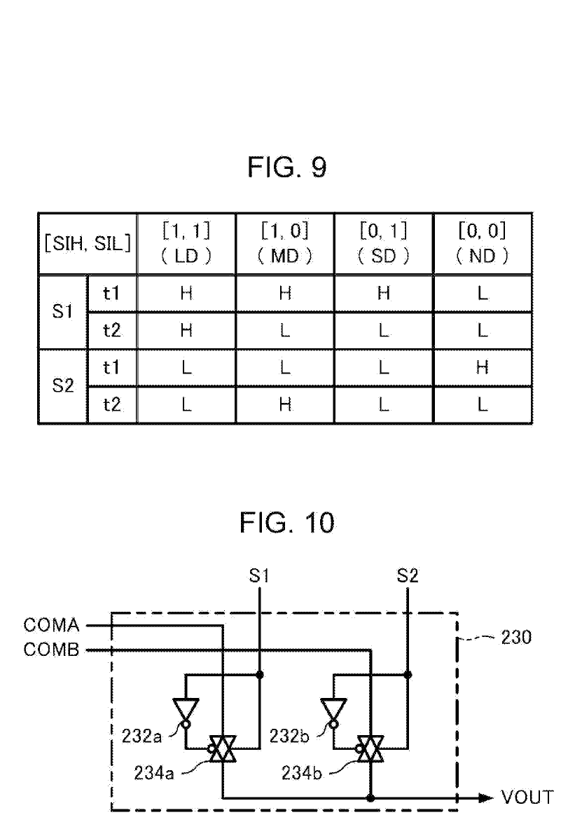

FIG. 9 is a diagram illustrating an example of contents of decoding by the decoders 216. Each of the decoders 216 generates and outputs selection signals S1 and S2 by decoding the print data item [SIH, SIL] latched by the corresponding latch circuit 214 with the content illustrated in FIG. 9. For example, when the input print data item [SIH, SIL] is [1, 0], a target one of the decoders 216 outputs logic levels of the selection signal S1 to a corresponding one of the selection circuits 230 as H and L levels in the periods t1 and t2, respectively, and outputs logic levels of the selection signal S2 to the corresponding one of the selection circuits 230 as L and H levels in the periods t1 and t2, respectively.

The selection circuits 230 are provided for the individual p ejecting sections 600. In other words, the drive signal selection circuit 200 has p selection circuits 230 that are at least the same in number as the p ejecting sections 600. FIG. 10 is a diagram illustrating a configuration of one of the selection circuits 230 that corresponds to one of the ejecting sections 600. As illustrated in FIG. 10, the selection circuit 230 has inverters 232a and 232b, which are NOT circuits, and transfer gates 234a and 234b.

While the selection signal S1 is input to a positive control end which is not marked with a circle at the transfer gate 234a, the selection signal S1 is logically inverted by the inverter 232a and is input to a negative control end marked with a circle at the transfer gate 234a. In addition, the drive signal COMA is supplied to an input end of the transfer gate 234a. While the selection signal S2 is input to a positive control end which is not marked with a circle at the transfer gate 234b, the selection signal S2 is logically inverted by the inverter 232b and is input to a negative control end marked with a circle at the transfer gate 234b. In addition, the drive signal COMB is supplied to an input end of the transfer gate 234b. Then, an output end of the transfer gate 234a and an output end of the transfer gate 234b are commonly coupled. A signal at a coupling end to which the output end of the transfer gate 234a and the output end of the transfer gate 234b are commonly coupled is output as the drive voltage VOUT.

Specifically, the input end and the output end of the transfer gate 234a are made conductive when the selection signal S1 is in the H level, and the input end and the output end of the transfer gate 234a are made non-conductive when the selection signal S1 is in the L level. In addition, the input end and the output end of the transfer gate 234b are made conductive when the selection signal S2 is in the H level, and the input end and the output end of the transfer gate 234b are made non-conductive when the selection signal S2 is in the L level. That is, the selection circuit 230 switches the conduction state between the input ends and the output ends of the transfer gates 234a and 234b based on the selection signals S1 and S2, to select or deselect the signal waveforms of the drive signals COMA and COMB supplied to the input ends of the transfer gates 234a and 234b, and output the drive voltage VOUT to the coupling end at which the output end of the transfer gate 234a and the output end of the transfer gate 234b are commonly coupled.

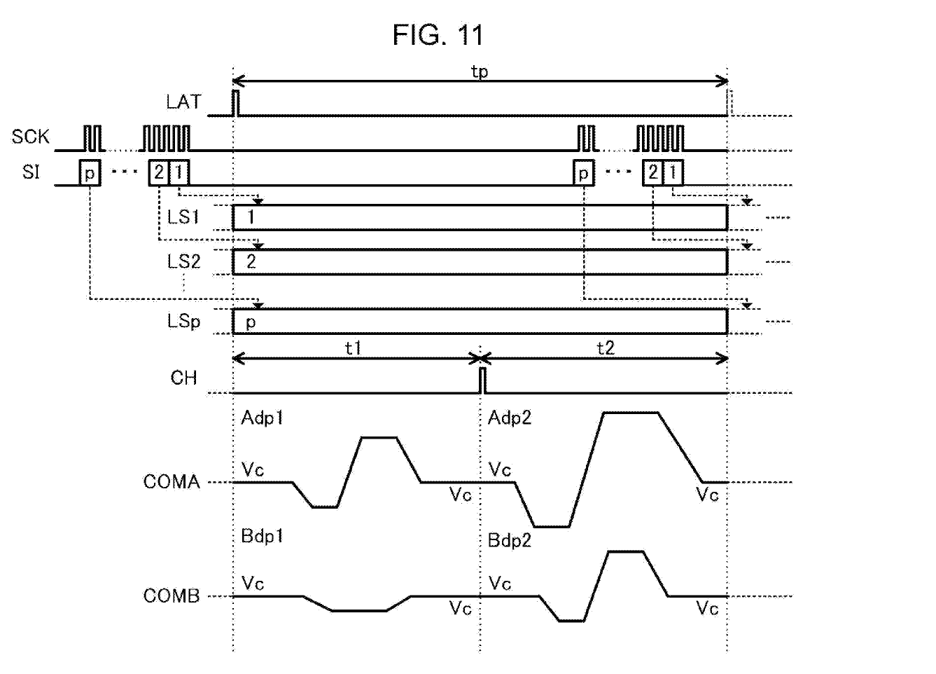

An operation of the drive signal selection circuits 200 will be described with reference to FIG. 11. FIG. 11 is a diagram for explaining an operation of the drive signal selection circuit 200. The print data items [SIH, SIL] included in the print data signal SI are serially input in synchronization with the clock signal SCK. Then, the print data items [SIH, SIL] are sequentially transferred by the registers 212 that constitute the shift register corresponding to the p ejecting sections 600 in synchronization with the clock signal SCK. Thereafter, when the supply of the clock signal SCK is stopped, the print data items [SIH, SIL] are held in the registers 212 corresponding to the p ejecting sections 600. Note that the print data items [SIH, SIL] included in the print data signal SI are input to the registers 212 that constitute the shift register in an order of the registers 212 corresponding to the ejecting sections 600 at the p-th stage, ..., the second stage, and the first stage.

When the latch signal LAT rises, each of the individual latch circuits 214 latches the print data items [SIH, SIL] held in the corresponding registers 212 all at once. Note that, in FIG. 11, LS1, LS2, ..., and LSp indicate the print data items [SIH, SIL] latched by the latch circuits 214 that correspond to the registers 212 at the first stage, the second stage, ..., and the p-th stage.

The decoder 216 outputs the logic levels of the selection signals S1 and S2 in each of the periods t1 and t2 with the contents illustrated in FIG. 9, according to sizes of dots defined by the latched print data items [SIH, SIL].

Specifically, when the input print data item [SIH, SIL] is [1, 1], the decoder 216 sets a logic level of the selection signal S1 to the H level and the H level in the periods t1 and t2, respectively, and sets a logic level of the selection signal S2 to the L level and the L level in the periods t1 and t2, respectively. In this case, the selection circuit 230 selects the trapezoidal waveform Adp1 in the period t1 and selects the trapezoidal waveform Adp2 in the period t2. As a result, at the output end of the selection circuit 230, the drive voltage VOUT that corresponds to the large dot LD illustrated in FIG. 7 is generated.

In addition, when the input print data [SIH, SIL] is [1, 0], the decoder 216 sets the logic levels of the selection signal S1 to the H level and the L level in the periods t1 and t2, respectively, and sets the logic levels of the selection signal S2 to the L level and the H level in the periods t1 and t2, respectively. In this case, the selection circuit 230 selects the trapezoidal waveform Adp1 in the period t1 and selects the trapezoidal waveform Bdp2 in the period t2. As a result, at the output end of the selection circuit 230, the drive voltage VOUT that corresponds to the medium dot MD illustrated in FIG. 7 is generated.

In addition, when the input print data [SIH, SIL] is [0, 1], the decoder 216 sets the logic levels of the selection signal S1 to the H level and the L level in the periods t1 and t2, respectively, and sets the logic levels of the selection signal S2 to the L level and the L level in the periods t1 and t2, respectively. In this case, the selection circuit 230 selects the trapezoidal waveform Adp1 in the period t1 and selects none of the trapezoidal waveforms Adp2 and Bdp2 in the period t2. As a result, at the output end of the selection circuit 230, the drive voltage VOUT that corresponds to the small dot SD illustrated in FIG. 7 is generated.

In addition, when the input print data [SIH, SIL] is [0, 0], the decoder 216 sets the logic levels of the selection signal S1 to the L level and the L level in the periods t1 and t2, respectively, and sets the logic levels of the selection signal S2 to the H level and the L level in the periods t1 and t2, respectively. In this case, the selection circuit 230 selects the trapezoidal waveform Bdp1 in the period t1 and selects none of the trapezoidal waveforms Adp2 and Bdp2 in the period t2. As a result, at the output end of the selection circuit 230, the drive voltage VOUT that corresponds to the non-recording ND illustrated in FIG. 7 is generated.

As described above, the drive signal selection circuit 200 generates and outputs the drive voltages VOUT[1] to VOUT[p] by selecting the signal waveforms of the drive signal COMA and the drive signal COMB based on the print data signal SI, the clock signal SCK, the latch signal LAT, and the change signal CH.

### 6. Fire Enclosure

In IEC 62368-1, fourth edition, circuits are classified into three types, namely, PS1, PS2, and PS3, according to their electric power supply capability. In a circuit of PS1, electric power does not exceed 15 W three seconds after initiation under any condition. In a circuit of PS2, electric power exceeds that of PS1 and does not exceed 100 W five seconds after initiation under any conditions. In a circuit of PS3, electric power exceeds 100 W. Electronic components classified as PS1 or PS2 are not required to be covered by a fire enclosure, whereas electronic components classified as PS3 are required to be covered by a fire enclosure.

Examples of the electronic components whose electric power is not less than 100 W include CPUs, chip capacitors, and electrolytic capacitors. Examples of the electronic components whose electric power is lower than 100 W include fuses, switches, and LEDs. LED is an abbreviation for Light Emitting Diode. Electronic components having an electric power of less than 100 W may be covered, together with electronic components having an electric power of 100 W or more, with a fire enclosure. However, when a switch or an LED is covered with the fire enclosure, access to the switch becomes difficult or light from the LED cannot be seen. Therefore, it is not preferable that the switch or the LED be covered with the fire enclosure.

In the printing apparatus 1, for example, some of the electronic components mounted on the control circuit board 10, some of the electronic components mounted on the power supply circuit board 11, and some of the electronic components mounted on the drive circuit board 12 have a possibility that electric power exceeds 100 W, and thus are required to be covered with a fire enclosure.

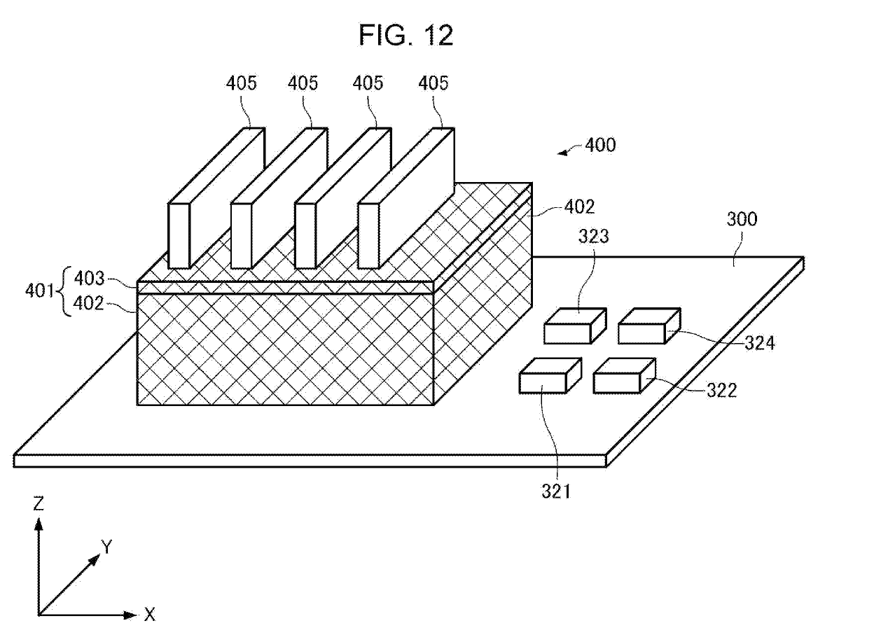

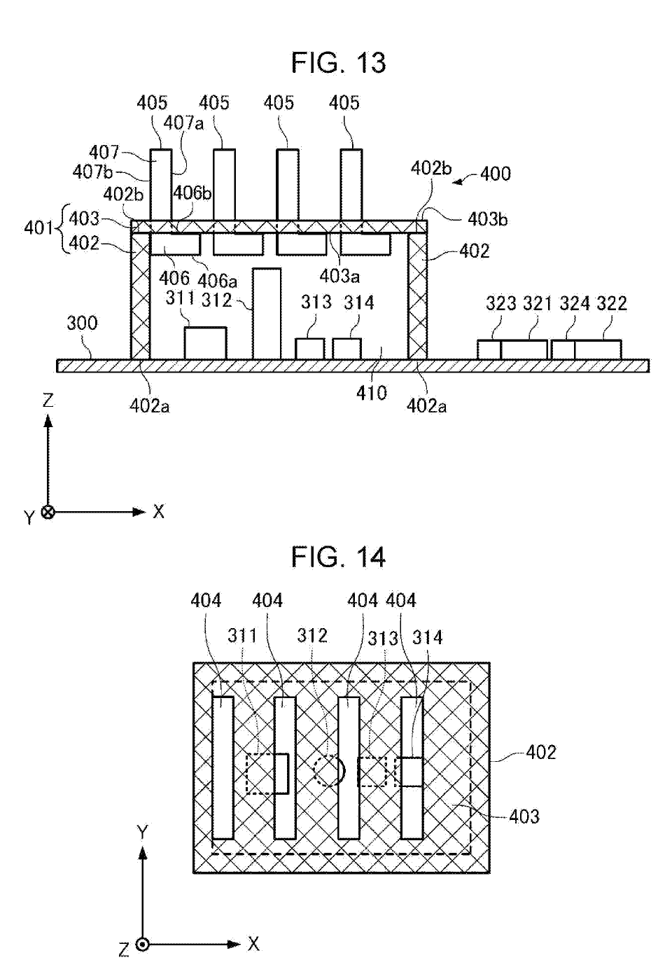

FIG. 12 is a perspective view of a substrate provided with a fire enclosure. FIG. 13 is a side view of the substrate in a state where the fire enclosure illustrated in FIG. 12 is cut. In FIGS. 12 and 13, an X-axis, a Y-axis, and a Z-axis which are orthogonal to each other are also illustrated for convenience of illustrating a correspondence relationship of directions in both drawings. FIG. 13 is a view seen from a starting point side of an arrow indicating the direction of the Y axis.

As illustrated in FIGS. 12 and 13, the substrate 300 is, for example, a printed circuit board, and includes a plurality of electronic components including electronic components 311, 312, 313, 314, 321, 322, 323, and 324. The substrate 300 is, for example, the drive circuit board 12, the control circuit board 10, or the power supply circuit board 11. For example, the electronic component 311 is supplied with an electric power of 100 W or more, and is covered with a fire enclosure 400 together with the electronic components 312, 313, and 314. The electronic component 311 may be, for example, a capacitor, a transistor, or a processor. Each of the electronic components 312, 313, and 314 may be supplied with an electric power of 100 W or more, or may be supplied with an electric power of less than 100 W. Furthermore, the electronic components 321, 322, 323, and 324 are supplied with an electric power of less than 100 W, and are not covered with the fire enclosure 400. Each of the electronic components 321, 322, 323, and 324 may be, for example, a fuse, a switch, or an LED.

The fire enclosure 400 includes a housing 401 and a plurality of heat dissipation members 405. The housing 401 includes a wall portion 402 and a top plate portion 403. The wall portion 402 and the top plate portion 403 may be integrated.

FIG. 14 is a view of the housing 401 as viewed from a distal end side of an arrow indicating the Z-axis direction. As illustrated in FIGS. 13 and 14, in order to suppress spread of fire, the housing 401 is a flame-retardant resin member of UL94 V-1 grade or higher, which is a standard for evaluating the combustibility of materials, and covers the electronic components 311, 312, 313, and 314. In UL94, three grades, V-0, V-1, and V-2 are defined as the grades of the vertical burning test. Materials of the V-0 grade have the highest flame retardancy, and materials of the V-1 grade have the second highest flame retardancy. For example, the materials of the V-0 grade have a burn time of 10 seconds or less, and the materials of the V-1 grade or V-2 grade have a burn time of 30 seconds or less. Furthermore, in the case of the materials of the V-0 grade or the V-1 grade, a cotton pad is not ignited by a molten material dropped by combustion, and in the case of the materials of the V-2 grade, a cotton pad is ignited by the molten material dropped by combustion. The flame-retardant resin of the V-1 grade or higher is a flame-retardant resin of the V-0 grade or the V-1 grade, and examples thereof include polyether ether ketone (PEEK), polyphenylene sulfide (PPS), polytetrafluoroethylene (PTFE), polyvinylidene fluoride (PVDF), polyetherimide (PEI), polyamide-imide (PAI), polyphenylsulfone (PPSU), polyimide (PI), and modified polyphenylene ether (PPE).

Furthermore, as illustrated in FIG. 13, the wall portion 402 has a bottom surface 402a and an upper surface 402b opposite to the bottom surface 402a, and the top plate portion 403 has a bottom surface 403a and an upper surface 403b opposite to the bottom surface 403a. The bottom surface 402a of the wall portion 402 is in contact with the substrate 300, and the upper surface 402b of the wall portion 402 and the bottom surface 403a of the top plate portion 403 are joined. Note that the state in which the bottom surface 402a of the wall portion 402 is in contact with the substrate 300 includes not only a state in which they are in direct contact with each other but also a state in which an adhesive or the like is interposed therebetween. For example, the wall portion 402 is fixed to the substrate 300 with an adhesive or bolts and nuts.

Since the wall portion 402 and the top plate portion 403, which are flame-retardant resin members, have high insulating properties, a contact surface between the wall portion 402 and the substrate 300 is insulated, and the risk of electrical leakage or short-circuiting is reduced. Note that an insulating member may be attached to a contact surface between the wall portion 402 and the substrate 300.

As illustrated in FIGS. 13 and 14, the wall portion 402 has a rectangular parallelepiped cavity extending from the bottom surface 402a to the upper surface 402b, and the electronic components 311, 312, 313, and 314 are accommodated in the cavity.

As illustrated in FIGS. 12 and 13, the top plate portion 403 is provided with the plurality of heat dissipation members 405 in order to enhance heat dissipation. For weight reduction, each of the plurality of heat dissipation members 405 is made of aluminum, and includes two plate members 406 and 407.

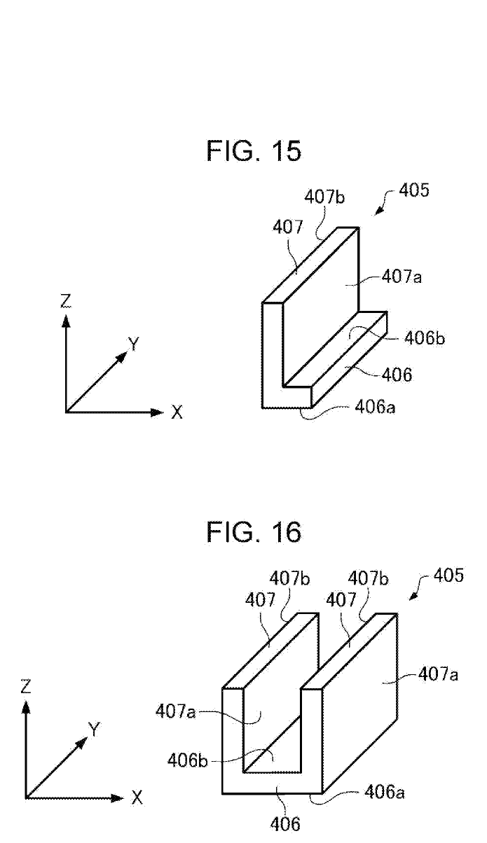

FIG. 15 is a perspective view of one of the heat dissipation members 405. As illustrated in FIGS. 13 and 15, the plate member 406 has a surface 406a and a surface 406b opposite to the surface 406a, the surface 406a faces the substrate 300, and the surface 406b is fixed in contact with the top plate portion 403. The plate member 407 has a surface 407a and a surface 407b opposite to the surface 407a, and is erected on the surface 406b of the plate member 406 so that the surfaces 407a and 407b extend along a direction normal to the surface 406b. For example, each of the heat dissipation members 405 including the plate members 406 and 407 is formed by bending one sheet metal. As illustrated in FIGS. 13 and 15, each of the heat dissipation members 405 has an L-shaped cross section taken along a plane intersecting the surfaces 406a and 406b of the plate member 406 and the surfaces 407a and 407b of the plate member 407.

As illustrated in FIG. 14, the top plate portion 403 has a plurality of openings 404 extending from the bottom surface 403a to the upper surface 403b, and the individual heat dissipation members 405 are inserted into the respective openings 404 and fixed to the top plate portion 403. For example, each of the plurality of heat dissipation members 405 is fixed to the top plate portion 403 by an adhesive, a screw, or fitting. In the case of fixation by fitting, either the heat dissipation member 405 or the top plate portion 403 may have a projected portion. Furthermore, for example, each of the plurality of heat dissipation members 405 and the top plate portion 403 may be fixed to each other by a screw using a helical thread insert, or may be fixed to each other by a bolt and a nut.

In the case where each of the plurality of heat dissipation members 405 is fixed to the top plate portion 403 with an adhesive, the adhesive preferably has high thermal conductivity in order to improve the heat dissipation.

With such a structure of the fire enclosure 400, the cavity portion of the wall portion 402 of the housing 401 forms a sealed space 410, and the electronic components 311, 312, 313, and 314 mounted on the substrate 300 are disposed in the sealed space 410. That is, since the electronic components 311, 312, 313, and 314 are surrounded by the wall portion 402 and the top plate portion 403, which are made of flame-retardant resin members of the V-1 grade or higher, and are covered with the fire enclosure 400, the spread of fire can be prevented even if any of the electronic components 311, 312, 313, and 314 ignites. Note that the cavity portion of the wall portion 402 need not form a completely sealed space, and there may be a slight clearance allowed in the fourth edition of IEC 62368-1.

Furthermore, heat that is generated by the electronic components 311, 312, 313, and 314 is conducted to the plurality of heat dissipation members 405, and is efficiently dissipated from the plurality of heat dissipation members 405.

Note that the transport mechanism 4 is an example of a "transport section". The electronic component 311 is an example of a "first element", and the electronic component 321 is an example of a "second element". The heat dissipation members 405 are examples of "first heat dissipation members", the plate member 406 is an example of a "first plate member", and the plate member 407 is an example of a "second plate member". The surface 406a of the plate member 406 is an example of a "first surface", and the surface 406b of the plate member 406 is an example of a "second surface". The surface 407a of the plate member 407 is an example of a "third surface", and the surface 407b of the plate member 407 is an example of a "fourth surface". The bottom surface 402a of the wall portion 402 is an example of a "ninth surface", and the upper surface 402b of the wall portion 402 is an example of a "tenth surface". The bottom surface 403a of the top plate portion 403 is an example of an "eleventh surface", and the upper surface 403b of the top plate portion 403 is an example of a "twelfth surface".

### 7. Operational Effects

As described above, according to the printing apparatus 1 of this embodiment, the electronic component 311, which is relatively easily ignited because the electric power to be supplied is 100 W or more, is covered with the fire enclosure 400 including the housing 401 made of the flame-retardant resin member of the V-1 grade or higher and the heat dissipation members 405 made of the flame-retardant aluminum member. Therefore, the possibility of fire spread due to ignition of the electronic component 311 is reduced. In addition, since the wall portion 402 made of a flame-retardant resin member having a high insulating property is provided on the contact surface between the fire enclosure 400 and the substrate 300, the risk of electric leakage or short-circuiting is reduced.

In addition, according to the printing apparatus 1 of this embodiment, since the plurality of heat dissipation members 405 made of aluminum are fixed in contact with the top plate portion 403, it is possible to improve heat dissipation in the fire enclosure 400. Furthermore, according to the printing apparatus 1 of this embodiment, since the housing 401 is formed of a flame-retardant resin member which is lighter than metal, the weight of the fire enclosure 400 is also reduced. Therefore, according to the printing apparatus 1 of this embodiment, it is possible to achieve both an improvement in heat dissipation and a reduction in weight of the fire enclosure 400.

Moreover, according to the printing apparatus 1 of this embodiment, since the small heat dissipation members 405 of the number necessary for sufficient heat dissipation are fixed to the top plate portion 403, a dedicated large heat sink corresponding to a size of the top plate portion 403 is not required, and a production cost of the heat dissipation members 405 and a production cost of the fire enclosure 400 are reduced.

Furthermore, according to the printing apparatus 1 of this embodiment, a portion of the ink ejected from the print heads 22-1 to 22-n becomes mist and floats in the air before landing on the medium P, and the liquid landed on the medium P also becomes mist by re-floating before being absorbed and solidified by the medium P. However, since the electronic component 311, which is relatively easily ignited, is covered with the fire enclosure 400, the possibility of ignition of the electronic component 311 due to electric leakage or short-circuiting caused by the ink mist is reduced.

In particular, in a relatively small printing apparatus 1 in which a size of the medium P is equal to or smaller than a short side length of A3 paper, an inside of the housing is likely to have a high temperature, and ink mist is likely to adhere to the substrate 300. However, the possibility of ignition of the electronic component 311 is reduced by the fire enclosure 400.

### 8. Modifications

The present disclosure is not limited to the embodiment described above, and various modifications may be made without departing from the scope of the present disclosure.

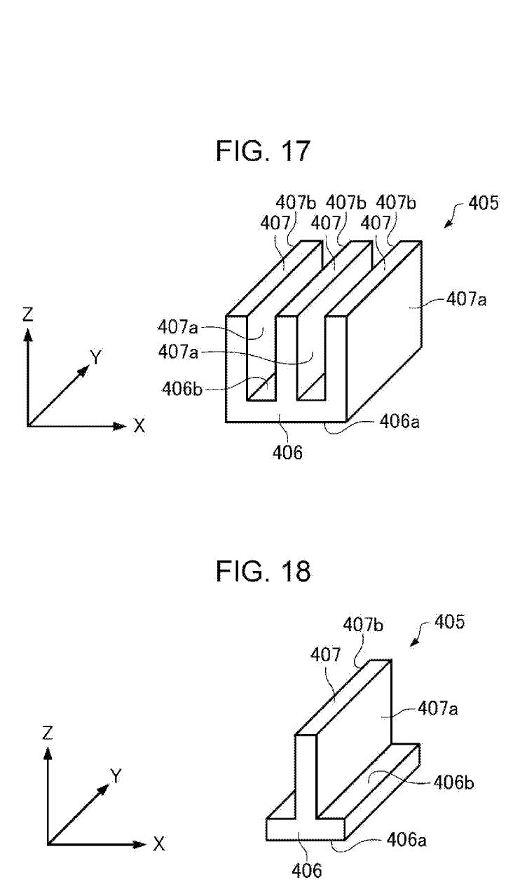

For example, in the above-described embodiment, the shape of the cross sections of the heat dissipation members 405 of the fire enclosure 400 is an L-shape, but may be a shape other than this. For example, as illustrated in FIG. 16, each of the heat dissipation members 405 may include a plate member 406 and two plate members 407 made of aluminum, and a shape of a cross section taken along a plane intersecting surfaces 406a and 406b of the plate member 406 and surfaces 407a and 407b of each of the plate members 407 may be a U-shape. In addition, for example, as illustrated in FIG. 17, each of the heat dissipation members 405 may include a plate member 406 and three plate members 407 made of aluminum, and a shape of a cross section taken along a plane intersecting the surfaces 406a and 406b of the plate member 406 and the surfaces 407a and 407b of each of the plate members 407 may be an E shape. Furthermore, for example, as illustrated in FIG. 18, each of the heat dissipation members 405 may include plate members 406 and 407 made of aluminum, and a shape of a cross section taken along a plane intersecting with the surfaces 406a and 406b of the plate member 406 and the surfaces 407a and 407b of the plate member 407 may be a T shape. Although not illustrated, in any of the heat dissipation members 405 illustrated in FIGS. 16 to 18, the surface 406a of the plate member 406 faces the substrate 300, and the surface 406b of the plate member 406 is fixed in contact with the top plate portion 403. Furthermore, in order to enhance the heat radiation property, it is preferable that the plurality of heat dissipation members 405 are provided on the top plate portion 403.

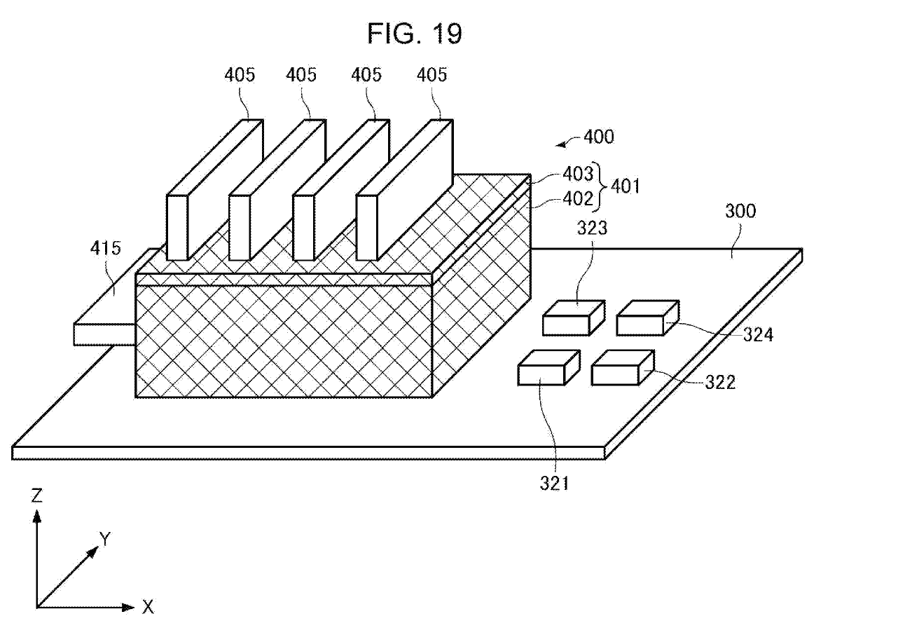

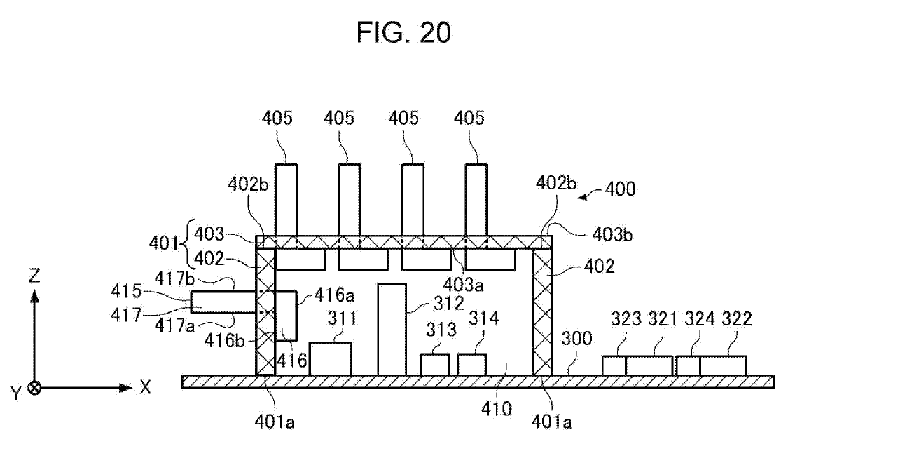

In addition, in the above-described embodiment, the wall portion 402 of the housing 401 of the fire enclosure 400 is not provided with a heat dissipation member, but as illustrated in FIGS. 19 and 20, the wall portion 402 may be provided with a heat dissipation member 415. For weight reduction, the heat dissipation member 415 is made of aluminum and includes plate members 416 and 417. As illustrated in FIGS. 19 and 20, the plate member 416 has a surface 416a and a surface 416b opposite to the surface 416a, and the surface 416b is fixed in contact with the wall portion 402. The plate member 417 has a surface 417a and a surface 417b opposite to the surface 417a, and is erected on the surface 416b of the plate member 416 so that the surfaces 417a and 417b extend along a direction normal to the surface 416b. For example, the heat dissipation member 415 including the plate members 416 and 417 is formed by bending one sheet metal. As described above, since the heat dissipation members 405 are fixed to the top plate portion 403 of the housing 401 and the heat dissipation member 415 is also fixed to the wall portion 402, the heat dissipation property of the fire enclosure 400 is improved.

Note that, in FIGS. 19 and 20, one heat dissipation member 415 is provided on the wall portion 402, but a plurality of heat dissipation members 415 may be provided on the wall portion 402 in order to improve heat dissipation. Furthermore, in FIGS. 19 and 20, the heat dissipation member 415 has an L-shaped cross section taken along a plane intersecting the surfaces 416a and 416b of the plate member 416 and the surfaces 417a and 417b of the plate member 417, but may have a U-shaped, E-shaped, or T-shaped cross section as in the heat dissipation members 405 illustrated in FIGS. 16 to 18.

The heat dissipation member 415 is an example of a "second heat dissipation member", the plate member 416 is an example of a "third plate member", and the plate member 417 is an example of a "fourth plate member". The surface 416a of the plate member 416 is an example of a "fifth surface", and the surface 416b of the plate member 416 is an example of a "sixth surface". The surface 417a of the plate member 417 is an example of a "seventh surface", and the surface 417b of the plate member 417 is an example of an "eighth surface".

The present disclosure includes substantially the same configurations (for example, configurations having the same functions, methods, and results, or configurations having the same objects and effects) as the configurations described in this embodiment. Furthermore, the present disclosure includes configurations in which non-essential portions of the configuration described in this embodiment are replaced. In addition, the present disclosure includes configurations that achieve the same operational effects or configurations that can achieve the same objects as those of the configurations described in this embodiment. Furthermore, the present disclosure includes configurations in which a known technology is added to the configurations described in this embodiment.

The embodiment and the modifications described above are merely examples, and the present disclosure is not limited thereto. For example, the embodiment and each of the modifications may be combined as appropriate.

The following contents are derived from the above-described embodiment and the modifications.

According to an aspect, a printing apparatus includes a transport section that transports a medium, an ejecting section that ejects liquid onto the medium, and a substrate including a first element to be supplied with an electric power of 100 W or more and a second element to be supplied with an electric power of less than 100 W. The first element is covered with a fire enclosure. The second element is not covered with the fire enclosure. The fire enclosure includes a housing and a first heat dissipation member. The housing is a flame-retardant resin member of at least V-1 grade, includes a wall portion and a top plate portion, and covers the first element. The wall portion is in contact with the substrate. The first heat dissipation member is made of aluminum and includes a first plate member and a second plate member. The first plate member has a first surface and a second surface opposite to the first surface. The first surface faces the substrate. The second surface is fixed in contact with the top plate portion. The second plate member has a third surface and a fourth surface opposite to the third surface, and the third surface and the fourth surface are erected on the second surface along a direction normal to the second surface.

According to the printing apparatus, since the first element which is relatively easily ignited since the electric power to be supplied is equal to or higher than 100 W is covered with the fire enclosure including the housing formed of the flame-retardant resin member of V-1 grade or higher and the heat dissipation member formed of flame-retardant aluminum, the possibility of the fire spreading due to the ignition of the first element is reduced. Furthermore, since the wall portion made of the flame-retardant resin member having a high insulating property is provided on the contact surface between the fire enclosure and the substrate, the risk of electric leakage or short-circuiting is reduced.

Moreover, according to the printing apparatus, since the heat dissipation member made of aluminum is fixed in contact with the top plate portion, it is possible to improve heat dissipation in the fire enclosure. In addition, according to the printing apparatus, since the housing is formed of a flame-retardant resin member which is lighter than metal, a weight of the fire enclosure is also reduced. Therefore, according to the printing apparatus, it is possible to achieve both an improvement in heat dissipation and a reduction in weight of the fire enclosure.

Furthermore, according to the printing apparatus, a portion of the liquid ejected from the ejecting sections becomes mist and floats in the air before landing, and the liquid landed on the medium also floats again and becomes mist before being absorbed and solidified on the medium. However, since the first element which is relatively easily ignited is covered with the fire enclosure, a concern that the first element is ignited due to occurrence of electric leakage or short-circuiting caused by the mist is reduced.

According to an aspect of the printing apparatus, a shape of a cross section of the first heat dissipation member taken along a plane intersecting the first surface and the third surface may be an L shape, a U shape, an E shape, or a T shape.

According to an aspect of the printing apparatus, the wall portion may be fixed to the substrate with an adhesive or with a bolt and a nut.

According to an aspect of the printing apparatus, the first heat dissipation member may be fixed to the top plate portion with an adhesive, with a screw, or by fitting.

According to an aspect of the printing apparatus, the first heat dissipation member and the top plate portion may be fixed to each other with a screw using a helical thread insert.

According to an aspect of the printing apparatus, the fire enclosure may include a plurality of heat dissipation members including the first heat dissipation member, and each of the plurality of heat dissipation members may be made of aluminum and may be fixed to the top plate portion.

According to the printing apparatus, since the small heat dissipation members of the number necessary for sufficient heat dissipation are fixed to the top plate portion, a dedicated large heat sink corresponding to a size of the top plate portion is not required, and a production cost of the heat dissipation members and a production cost of the fire enclosure are reduced.

According to an aspect of the printing apparatus, the fire enclosure may include a second heat dissipation member, the second heat dissipation member may be made of aluminum and may include a third plate member and a fourth plate member, the third plate member may have a fifth surface and a sixth surface opposite to the fifth surface, the sixth surface may be fixed in contact with the wall portion, the fourth plate member may have a seventh surface and an eighth surface opposite to the seventh surface, and the seventh surface and the eighth surface may be erected on the sixth surface along a direction normal to the sixth surface.

According to the printing apparatus, since the first heat dissipation member is fixed to the top plate portion of the housing and the second heat dissipation member is also fixed to the wall portion, the heat dissipation property of the fire enclosure is improved.

According to an aspect of the printing apparatus, the first element may be a capacitor, a transistor, or a processor.

According to an aspect of the printing apparatus, the second element may be a fuse, a switch, or an LED.

According to an aspect of the printing apparatus, the substrate may be a printed circuit board.

According to an aspect of the printing apparatus, the ejecting section may include a piezoelectric element.

According to an aspect of the printing apparatus, the substrate may be a drive circuit board on which a drive circuit that generates a drive signal for causing the ejecting section to eject the liquid is mounted, a control circuit board on which a control circuit that controls ejection of the liquid from the ejecting section is mounted, or a power supply circuit board on which a power supply circuit is mounted.

According to the printing apparatus, it is possible to reduce the possibility that the drive circuit board, the control circuit board, or the power supply circuit board on which the first element for which the electric power to be supplied is equal to or greater than 100 W is mounted is ignited.

According to an aspect of the printing apparatus, the drive circuit may include a class-D amplifier which is an amplification circuit.

According to an aspect of the printing apparatus, the drive signal output from the drive circuit may be an analog signal.

According to an aspect of the printing apparatus, the control circuit may output a base drive signal which is a digital signal serving as a base of the drive signal output from the drive circuit.

According to an aspect of the printing apparatus, the power supply circuit may include a voltage conversion circuit and a smoothing circuit.

According to an aspect of the printing apparatus, the voltage conversion circuit may include a transformer that transforms an alternating-current voltage of a commercial power supply.

According to an aspect of the printing apparatus, the smoothing circuit may include a rectifier circuit and a capacitor.

According to an aspect of the printing apparatus, the rectifier circuit may be a diode bridge circuit and rectifies an alternating-current voltage converted by the voltage conversion circuit.

According to an aspect of the printing apparatus, the wall portion may have a ninth surface and a tenth surface opposite to the ninth surface, the top plate portion may have an eleventh surface and a twelfth surface opposite to the eleventh surface, the ninth surface may be in contact with the substrate, the tenth surface and the eleventh surface may be bonded, the wall portion may have a cuboid cavity extending from the ninth surface to the tenth surface, the first element may be accommodated in the cavity, the top plate portion may have an opening extending from the eleventh surface to the twelfth surface, and the first heat dissipation member may be inserted into the opening.

What is claimed is:

1. A printing apparatus comprising:
a transport section that transports a medium;
an ejecting section that ejects liquid onto the medium; and
a substrate including a first element to be supplied with an electric power of 100 W or more and a second element to be supplied with an electric power of less than 100 W, wherein
the first element is covered with a fire enclosure,
the second element is not covered with the fire enclosure,
the fire enclosure includes a housing and a first heat dissipation member,
the housing is a flame-retardant resin member of at least V-1 grade, includes a wall portion and a top plate portion, and covers the first element,
the wall portion is in contact with the substrate,
the first heat dissipation member is made of aluminum and includes a first plate member and a second plate member,
the first plate member has a first surface and a second surface opposite to the first surface,
the first surface faces the substrate,
the second surface is fixed in contact with the top plate portion, and
the second plate member has a third surface and a fourth surface opposite to the third surface, and the third surface and the fourth surface are erected on the second surface along a direction normal to the second surface.

2. The printing apparatus according to claim 1, wherein a shape of a cross section of the first heat dissipation member taken along a plane intersecting the first surface and the third surface is an L shape, a U shape, an E shape, or a T shape.

3. The printing apparatus according to claim 1, wherein the wall portion is fixed to the substrate with an adhesive or with a bolt and a nut.

4. The printing apparatus according to claim 1, wherein the first heat dissipation member is fixed to the top plate portion with an adhesive, with a screw, or by fitting.

5. The printing apparatus according to claim 1, wherein the first heat dissipation member and the top plate portion are fixed to each other with a screw using a helical thread insert.

6. The printing apparatus according to claim 1, wherein
the fire enclosure includes a plurality of heat dissipation members including the first heat dissipation member, and
each of the plurality of heat dissipation members is made of aluminum and is fixed to the top plate portion.

7. The printing apparatus according to claim 1, wherein
the fire enclosure includes a second heat dissipation member,
the second heat dissipation member is made of aluminum and includes a third plate member and a fourth plate member,
the third plate member has a fifth surface and a sixth surface opposite to the fifth surface,
the sixth surface is fixed in contact with the wall portion, and
the fourth plate member has a seventh surface and an eighth surface opposite to the seventh surface, and the seventh surface and the eighth surface are erected on the sixth surface along a direction normal to the sixth surface.

8. The printing apparatus according to claim 1, wherein the first element is a capacitor, a transistor, or a processor.

9. The printing apparatus according to claim 1, wherein the second element is a fuse, a switch, or an LED.

10. The printing apparatus according to claim 1, wherein the substrate is a printed circuit board.

11. The printing apparatus according to claim 1, wherein the ejecting section includes a piezoelectric element.

12. The printing apparatus according to claim 1, wherein the substrate is a drive circuit board on which a drive circuit that generates a drive signal for causing the ejecting section to eject the liquid is mounted, a control circuit board on which a control circuit that controls ejection of the liquid from the ejecting section is mounted, or a power supply circuit board on which a power supply circuit is mounted.

13. The printing apparatus according to claim 12, wherein the drive circuit includes a class-D amplifier which is an amplification circuit.

14. The printing apparatus according to claim 12, wherein the drive signal output from the drive circuit is an analog signal.

15. The printing apparatus according to claim 12, wherein the control circuit outputs a base drive signal which is a digital signal serving as a base of the drive signal output from the drive circuit.

16. The printing apparatus according to claim 12, wherein the power supply circuit includes a voltage conversion circuit and a smoothing circuit.

17. The printing apparatus according to claim 16, wherein the voltage conversion circuit includes a transformer that transforms an alternating-current voltage of a commercial power supply.

18. The printing apparatus according to claim 16, wherein the smoothing circuit includes a rectifier circuit and a capacitor.

19. The printing apparatus according to claim 18, wherein the rectifier circuit is a diode bridge circuit and rectifies an alternating-current voltage converted by the voltage conversion circuit.

20. The printing apparatus according to claim 1, wherein
the wall portion has a ninth surface and a tenth surface opposite to the ninth surface,
the top plate portion has an eleventh surface and a twelfth surface opposite to the eleventh surface,
the ninth surface is in contact with the substrate,
the tenth surface and the eleventh surface are bonded,
the wall portion has a cuboid cavity extending from the ninth surface to the tenth surface,
the first element is accommodated in the cavity,
the top plate portion has an opening extending from the eleventh surface to the twelfth surface, and
the first heat dissipation member is inserted into the opening.
